(19) United States
(12) Patent Application Publication
(10) Pub. No.: US 2025/0284272 A1
(43) Pub. Date: Sep. 11, 2025

(54) SYSTEMS AND METHODS FOR VARIABLE POWER GENERATION ASSET FAILURE PREDICTION

(71) Applicant: Utopus Insights, Inc., Valhalla, NY (US)

(72) Inventors: Chanaka Keerthisinghe, Mount Wellington (NZ); Kim Fluchel, Pittstown, NJ (US); Douglas Guthrie, Valhalla, NY (US); Thomas N. Theis, Croton On Hudson, NY (US); Ana Rita Reis Machado da Silva, Fradelos VNF (PT); Xueyin Yu, White Plains, NY (US)

(73) Assignee: Utopus Insights, Inc., Valhalla, NY (US)

(21) Appl. No.: 19/074,280

(22) Filed: Mar. 7, 2025

Related U.S. Application Data
(60) Provisional application No. 63/562,648, filed on Mar. 7, 2024.

(51) Int. Cl. G05B 23/02; G05B 13/04

(52) U.S. Cl. CPC G05B 23/024; G05B 13/041; G05B 23/027

(57) ABSTRACT

An example method includes receiving monitoring data from at least one variable power generation asset, predicting, using a trained machine model, a predicted operational stressor value based on features of the monitoring data, the operational stressor value being a stressor metric of an operational stressor, comparing a difference of the predicted operational stressor value to a reported operational stressor value to create a residual value, retrieving a particular anomaly threshold from a plurality of anomaly thresholds, the particular anomaly threshold being selected based on at least one manufacturing variable of a component and a risk category that is based on an operational survivability analysis over time for that at least one manufacturing variable in a presence of the operational stressor, the at least one manufacturing variable being from manufacturing data, and providing a notification of potential failure when the residual value is outside the particular anomaly threshold.

### CROSS-REFERENCE TO RELATED APPLICATION

This application claims priority to U.S. Provisional Patent Application No. 63/562,648, filed on Mar. 7, 2024, and entitled “Systems and Methods for Renewable Energy Asset Health Identification,” which is incorporated in its entirety herein by reference.

### TECHNICAL FIELD

Embodiments of the present invention(s) generally relate to predicting failures of variable power generation assets, such as those that generate power using renewable energy, and in particular to predicting failures of variable power generation assets using manufacturing data.

### BACKGROUND

Variable power generation assets (for example, wind turbines) are becoming increasingly common. For example, wind farms located in remote portions of the world may include tens to hundreds of wind turbines. Unfortunately, a wind turbine includes many components that, if they fail, will render the wind turbine inoperable until fixed.

Due to the large number of components of each wind turbine, the number of wind turbines, the distribution of the wind turbines, and their remote locations, it may be very difficult to predict the likelihood of failures. Moreover, it may be difficult to target the maintenance or repair work to be done on a wind turbine prior to failure.

Generally, wind turbine operators, such as power companies, wait until wind turbines fail to take action. Once a particular wind turbine reaches the point of failure, the failure of one component may cause stress and damage to other components of the wind turbine. As a result, a certain number of expensive wind turbines are lost.

### SUMMARY

An example non-transitory computer-readable medium comprises executable instructions. The executable instructions may be executed by one or more processors to perform a method. The method comprising receiving monitoring data from at least one variable power generation asset, predicting, using a trained machine model, a predicted operational stressor value based on features of the monitoring data, the operational stressor value being a stressor metric of an operational stressor of a condition of at least a part of the at least one variable power generation asset, comparing a difference of the predicted operational stressor value to a reported operational stressor value to create a residual value, the reported operational stressor value having been being based on a measurement of the reported operational stressor value of the at least one variable power generation asset, retrieving a particular anomaly threshold from a plurality of anomaly thresholds, the particular anomaly threshold being selected based on at least one manufacturing variable of a component of the at least one variable power generation asset and a risk category that is based on an operational survivability analysis over time for that at least one manufacturing variable in a presence of the operational stressor, the at least one manufacturing variable being from manufacturing data, and providing a notification of potential failure when the residual value is outside the particular anomaly threshold.

The method may further comprise receiving the manufacturing data that includes manufacturing variables for different components of a plurality of variable power generation assets including the at least one manufacturing variable, each manufacturing variable of the manufacturing data including a plurality of dimensional metrics, and, for each manufacturing variable: sorting the plurality of dimensional metrics based on size, performing a manufacturing survivability analysis on different percentile ranges of the sorted dimensional metrics to determine manufacturing risk categories based at least in part on risk of failure over time, and performing the operational survivability analysis on at least a subset of risk categories to determine operational risk categories based on risk of failure over time in the presence of at least one operational risk variable.

In some embodiments, performing the manufacturing survivability analysis on the different percentile ranges of the sorted dimensional metrics to determine the manufacturing risk categories based at least in part on the risk of failure over time comprises determining at least one first p-value to determine significance of the different percentile ranges of the sorted dimensional metrics, at least one manufacturing risk category being determined based, at least in part, on the first p-value being sufficiently low.

In various embodiments, performing the operational survivability analysis on at least the subset of risk categories to determine the operational risk categories based on the risk of failure over time in the presence of at least one operational risk variable comprises determining at least one second p-value to determine significance of the different operational risk categories, at least one operational risk category being determined based, at least in part, on the second p-value being sufficiently low.

In addition to any or all the above, in any combination, the method may further comprise identifying different anomaly thresholds for different operational risk categories and storing the different anomaly thresholds within the plurality of anomaly thresholds.

In addition to any or all the above, in any combination, in some embodiments the predicted operational stressor is a predicted bearing temperature and the reported operational stressor value is a reported bearing temperature. Alternately, the predicted operational stressor may be a predicted bearing vibration and the reported operational stressor value may be a reported bearing vibration.

In some embodiments, the manufacturing variable is selected from a housing drill diameter, a spacer width, or an axial clearance reduction after assembly. Further, the may be, for example, lagged bearing temperature and lagged and current active power.

In various embodiments, the at least one variable power generation asset is a wind turbine. The manufacturing variables for different components of the manufacturing data may be related to gearbox components.

In some embodiments, the model is one of a plurality of models and each model of the plurality of models being for a different variable power generation asset. The model may be, for example, an XGBoost based learning model.

An example system comprises at least one processor and a non-transitory computer readable memory medium. The executable instructions may be executable by the at least one processor to perform the method. The method may comprise receiving monitoring data from at least one variable power generation asset, predicting, using a trained machine model, a predicted operational stressor value based on features of the monitoring data, the operational stressor value being a stressor metric of an operational stressor of a condition of at least a part of the at least one variable power generation asset, comparing a difference of the predicted operational stressor value to a reported operational stressor value to create a residual value, the reported operational stressor value having been being based on a measurement of the reported operational stressor value of the at least one variable power generation asset, retrieving a particular anomaly threshold from a plurality of anomaly thresholds, the particular anomaly threshold being selected based on at least one manufacturing variable of a component of the at least one variable power generation asset and a risk category that is based on an operational survivability analysis over time for that at least one manufacturing variable in a presence of the operational stressor, the at least one manufacturing variable being from manufacturing data, and providing a notification of potential failure when the residual value is outside the particular anomaly threshold.

The method may further comprise receiving the manufacturing data that includes manufacturing variables for different components of a plurality of variable power generation assets including the at least one manufacturing variable, each manufacturing variable of the manufacturing data including a plurality of dimensional metrics, and, for each manufacturing variable: sorting the plurality of dimensional metrics based on size, performing a manufacturing survivability analysis on different percentile ranges of the sorted dimensional metrics to determine manufacturing risk categories based at least in part on risk of failure over time, and performing the operational survivability analysis on at least a subset of risk categories to determine operational risk categories based on risk of failure over time in the presence of at least one operational risk variable.

In some embodiments, performing the manufacturing survivability analysis on the different percentile ranges of the sorted dimensional metrics to determine the manufacturing risk categories based at least in part on the risk of failure over time comprises determining at least one first p-value to determine significance of the different percentile ranges of the sorted dimensional metrics, at least one manufacturing risk category being determined based, at least in part, on the first p-value being sufficiently low.

In various embodiments, performing the operational survivability analysis on at least the subset of risk categories to determine the operational risk categories based on the risk of failure over time in the presence of at least one operational risk variable comprises determining at least one second p-value to determine significance of the different operational risk categories, at least one operational risk category being determined based, at least in part, on the second p-value being sufficiently low.

In addition to any or all the above, in any combination, the method may further comprise identifying different anomaly thresholds for different operational risk categories and storing the different anomaly thresholds within the plurality of anomaly thresholds.

In addition to any or all the above, in any combination, in some embodiments the predicted operational stressor is a predicted bearing temperature and the reported operational stressor value is a reported bearing temperature. Alternately, the predicted operational stressor may be a predicted bearing vibration and the reported operational stressor value may be a reported bearing vibration.

In some embodiments, the manufacturing variable is selected from a housing drill diameter, a spacer width, or an axial clearance reduction after assembly. Further, the may be, for example, lagged bearing temperature and lagged and current active power.

In various embodiments, the at least one variable power generation asset is a wind turbine. The manufacturing variables for different components of the manufacturing data may be related to gearbox components.

In some embodiments, the model is one of a plurality of models and each model of the plurality of models being for a different variable power generation asset. The model may be, for example, an XGBoost based learning model.

An example method comprises receiving monitoring data from at least one variable power generation asset, predicting, using a trained machine model, a predicted operational stressor value based on features of the monitoring data, the operational stressor value being a stressor metric of an operational stressor of a condition of at least a part of the at least one variable power generation asset, comparing a difference of the predicted operational stressor value to a reported operational stressor value to create a residual value, the reported operational stressor value having been being based on a measurement of the reported operational stressor value of the at least one variable power generation asset, retrieving a particular anomaly threshold from a plurality of anomaly thresholds, the particular anomaly threshold being selected based on at least one manufacturing variable of a component of the at least one variable power generation asset and a risk category that is based on an operational survivability analysis over time for that at least one manufacturing variable in a presence of the operational stressor, the at least one manufacturing variable being from manufacturing data, and providing a notification of potential failure when the residual value is outside the particular anomaly threshold.

The method may further comprise receiving the manufacturing data that includes manufacturing variables for different components of a plurality of variable power generation assets including the at least one manufacturing variable, each manufacturing variable of the manufacturing data including a plurality of dimensional metrics, and, for each manufacturing variable: sorting the plurality of dimensional metrics based on size, performing a manufacturing survivability analysis on different percentile ranges of the sorted dimensional metrics to determine manufacturing risk categories based at least in part on risk of failure over time, and performing the operational survivability analysis on at least a subset of risk categories to determine operational risk categories based on risk of failure over time in the presence of at least one operational risk variable.

In some embodiments, performing the manufacturing survivability analysis on the different percentile ranges of the sorted dimensional metrics to determine the manufacturing risk categories based at least in part on the risk of failure over time comprises determining at least one first p-value to determine significance of the different percentile ranges of the sorted dimensional metrics, at least one manufacturing risk category being determined based, at least in part, on the first p-value being sufficiently low.

In various embodiments, performing the operational survivability analysis on at least the subset of risk categories to determine the operational risk categories based on the risk of failure over time in the presence of at least one operational risk variable comprises determining at least one second p-value to determine significance of the different operational risk categories, at least one operational risk category being determined based, at least in part, on the second p-value being sufficiently low.

In addition to any or all the above, in any combination, the method may further comprise identifying different anomaly thresholds for different operational risk categories and storing the different anomaly thresholds within the plurality of anomaly thresholds.

In addition to any or all the above, in any combination, in some embodiments the predicted operational stressor is a predicted bearing temperature and the reported operational stressor value is a reported bearing temperature. Alternately, the predicted operational stressor may be a predicted bearing vibration and the reported operational stressor value may be a reported bearing vibration.

In some embodiments, the manufacturing variable is selected from a housing drill diameter, a spacer width, or an axial clearance reduction after assembly. Further, the may be, for example, lagged bearing temperature and lagged and current active power.

In various embodiments, the at least one variable power generation asset is a wind turbine. The manufacturing variables for different components of the manufacturing data may be related to gearbox components.

In some embodiments, the model is one of a plurality of models and each model of the plurality of models being for a different variable power generation asset. The model may be, for example, an XGBoost based learning model.

Another example method may comprise receiving SCADA data, operational alarm data, and sensor data for a variable power generation asset, receiving one or more survival probabilities for one or more components of the variable power generation asset, generating features based on the SCADA data, the operational alarm data, the sensor data, and the one or more survival probabilities, applying a trained model to the features to obtain a failure prediction for the variable power generation asset, generating, based on the failure prediction, an alert, and providing the alert.

The method may further comprise receiving manufacturing data for multiple components of multiple variable power generation assets, generating, based on the manufacturing data, multiple survival probabilities for the multiple components, and determining, based on the multiple survival probabilities, the one or more survival probabilities.

The multiple components include gearbox bearings, and the manufacturing data may include gearbox bearing measurement data and data calculated from the gearbox bearing measurement data. In some embodiments, generating, based on the manufacturing data, the multiple survival probabilities for the multiple components includes: receiving historical failure data for the multiple components, generating, based on the manufacturing data and the historical failure data, multiple survival analyses for the multiple components, and generating, based on the multiple survival analyses for the multiple components, the multiple survival probabilities for the multiple components.

In various embodiments, the method further comprises receiving multiple sets of SCADA data, multiple sets of operational alarm data, and multiple sets of sensor data for multiple variable power generation assets, receiving manufacturing data for multiple components of the multiple variable power generation assets, generating, based on the manufacturing data, multiple survival probabilities for the multiple components, generating, based on the multiple sets of SCADA data, the multiple sets of operational alarm data, the multiple sets of sensor data, and the manufacturing data, multiple sets of features, and training a model on the multiple sets of features to generate the trained model. The method may further comprise generating a failure prediction confidence and providing the failure prediction confidence.

An example system may comprise at least one processor and at least one memory including executable instructions that when executed by the at least one processor cause the system to receive SCADA data, operational alarm data, and sensor data for a variable power generation asset, receive one or more survival probabilities for one or more components of the variable power generation asset, generate features based on the SCADA data, the operational alarm data, the sensor data, and the one or more survival probabilities, apply a trained model to the features to obtain a failure prediction for the variable power generation asset, generate, based on the failure prediction, an alert, and provide the alert.

In various embodiments, the instructions further cause the system to receive multiple sets of SCADA data, multiple sets of operational alarm data, and multiple sets of sensor data for multiple variable power generation assets, receive manufacturing data for multiple components of the multiple variable power generation assets, generate, based on the manufacturing data, multiple survival probabilities for the multiple components, generate, based on the multiple sets of SCADA data, the multiple sets of operational alarm data, the multiple sets of sensor data, and the manufacturing data, multiple sets of features, and train a model on the multiple sets of features to generate the trained model. In some embodiments, the instructions further cause the system to generate a failure prediction confidence and provide the failure prediction confidence.

### BRIEF DESCRIPTION OF THE DRAWINGS

FIG. 1 depicts an example environment in which a variable power generation failure prediction system may operate in some embodiments.

FIG. 2 depicts a block diagram of a variable power generation failure prediction system in some embodiments.

FIG. 3A is a flow diagram depicting a method 300 for identifying high risk variable power generation assets or predicting failures of variable power generation assets according to some embodiments.

FIG. 3B depicts a table which includes example manufacturing data that may be utilized by a variable power generation failure prediction system in some embodiments.

FIG. 4 depicts three survival analysis plots of a manufacturing variable of a variable power generation asset used in manufacturing survivability analysis in some embodiments.

FIG. 5A depicts a manufacturing survival analysis plot 500 for a bivariate survival analysis of gearboxes of wind turbines grouped by percentiles according to the manufacturing variables “Spacer Width” and “11833T Housing Drill Diameter” in some embodiments.

FIG. 5B depicts an operational survival analysis plot 550 for a survival analysis for a component of a variable power generation asset in the presence of heat in some embodiments.

FIG. 6 depicts methods for identifying high risk variable power generation assets or components according to some embodiments.

FIG. 7 is a flow diagram depicting an example method that is an embodiment of the method depicted in FIG. 6.

FIG. 8 is an example of identifying high risk components in some embodiments in order to group components and/or variable power generation failure prediction systems into a high risk category in some embodiments.

FIG. 9 is a flow diagram depicting a method or predicting failure of variable power generation assets and a method for training a model that may be utilized by the variable power generation failure prediction system to predict failures, according to some embodiments.

FIG. 10 depicts a block diagram of an example digital device according to some embodiments.

Throughout the drawings, like reference numerals will be understood to refer to like parts, components, and structures.

### DETAILED DESCRIPTION

Various embodiments described herein address predicting failures of variable power generation assets using manufacturing and monitoring data. Although wind turbines are discussed herein as examples of variable power generation assets, it will be appreciated that one or more of the different approaches may be directed to other variable power generation assets (for example, assets and/or equipment of a solar farm) or combinations of different types of variable power generation assets.

Some systems and methods described herein are directed to identifying a risk of failure of wind turbines using manufacturing data and wind turbine monitoring data. The manufacturing data may include manufacturing variables related to components of wind turbines (e.g., wind turbine components). A manufacturing variable refers to any quantifiable factor used within the manufacturing process of components of a wind turbine. In the context of manufacturing a gearbox for a wind turbine, these variables may affect how components fit together and perform. Manufacturing variables are further described herein.

Although determining a risk of failure of a wind turbine is discussed herein, one or more of the systems and methods described may be used to detect risk of failure of the wind turbine gearbox or risk of failures of one or more of the components within the wind turbine gearbox. When referring to systems and methods for detecting or identifying risk of failure (or manufacturing) of the “wind turbine gearbox” or the “gearbox,” it will be appreciated that the systems and methods may detect or identify risk of failure of one or more components within the gearbox or the gearbox as a whole.

Some wind turbine gearboxes suffer premature failures while some operate for a long period of time with low maintenance costs. In some examples, the reason for early failure of a gearbox of a wind turbine could be due to either the manufacturing process of the gearbox (for example, defects or poor tolerances) and/or operational conditions (for example, heat or vibration caused by the components of the gearbox and/or environmental conditions). Although some systems and methods described herein are directed to identifying risk of failure of a gearbox of a wind turbine, it will be appreciated that at least some of the systems and methods described herein may apply to one or more different components of the wind turbines (or different variable power generation assets).

In some embodiments, manufacturing and monitoring data (e.g., wind turbine monitoring data) may be utilized to identify high failure risk of one or more wind turbine gearboxes as well as manufacturing problems that contribute to gearbox health risk factors.

A multivariate analysis may be utilized to help identify any number of risk factors in the manufacturing process. For example, by analyzing the manufacturing and current monitoring data associated with gearbox health risk factors, a multivariate analysis may be utilized to identify processes or materials that lead to a higher risk of failure of the gearbox (or components within the gearbox). The information from this analysis can then be used along with the monitoring data to see how the manufacturing data affects the failure rate.

In one example, manufacturing data may be sorted based on manufacturing variables (e.g., housing drill diameter is a manufacturing variable within the manufacturing data and is grouped and sorted based on diameter from smallest to largest). For a particular manufacturing variable (e.g., housing drill diameter), the dimensions of the variable (e.g., the diameter) may be broken into percentiles (e.g., the smallest range of diameters are from 0-20^{th} percentile).

An analysis (e.g., a manufacturing survival analysis as discussed herein) may be performed using the ranges in the different percentiles to identify the failure risk associated with each percentile. In various embodiments, percentile ranges are determined based on the significance of possible failure compared to other percentile ranges for that manufacturing variable. The survival analysis may be, for example, an assessment of historical data of how components that have manufacturing variables over time perform (e.g., how a gearbox with a housing drill diameter with a size from the 0-20^{th} percentile performs or fails over time relative to how a gearbox with a housing drill diameter with a size from the 21st-100^{th} percentile performs). Ranges of percentiles may be tested in view of the survival analysis to identify particular percentiles for one or more manufacturing variables. A multivariate analysis may be used to identify the effect of multiple items of manufacturing data on the failure risk.

The information about the high-risk categories (for example, low survival probabilities) can be used to predict gearbox failures or gearbox component failures. Additionally or alternatively, the information about the high-risk categories can be used to predict risk of failure or risk of unacceptable operational functions of gearboxes or gearbox component failures, particularly in the presence of an operational stressor such as generated heat or vibration. Additionally or alternatively, the information about the high-risk categories can be used to better predict failures of wind turbines and other variable power generation assets. The techniques disclosed herein provide predictions with improved recall and precision compared to previous techniques.

Although risk of failure is discussed herein with regard to gearboxes and other components, it will be appreciated that some embodiments may be utilized to identify or predict risk of suboptimal, inefficient, unstable, or unacceptable operational performance (either in addition to or instead of risk failure).

Various embodiments described herein overcome limitations of the prior art and may provide scalability, proactive warnings, or computational efficiency while providing improved accuracy with a centralized system for performing data analysis (for example, feature generation), model generation, model selection, model training, model testing, prediction, and alerts for failure prediction.

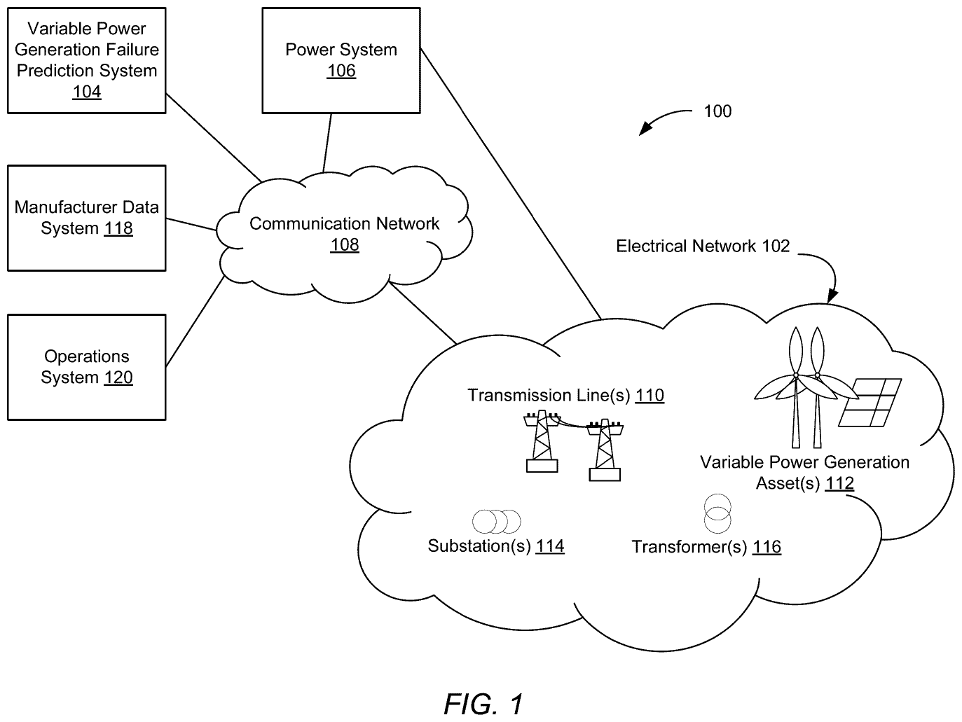

FIG. 1 depicts an example environment 100 in which a variable power generation failure prediction system may operate in some embodiments. The environment 100 includes an electrical network 102, a variable power generation failure prediction system 104, a power system 106, a manufacturer data system 118, and an operations system 120 in communication over a communication network 108. The electrical network 102 may include any number of transmission lines 110, the variable power generation assets 112, the substations 114, and the transformers 116. The electrical network 102 may include any number of electrical assets, including protective assets (for example, relays or other circuits to protect one or more assets), transmission assets (for example, lines or devices for delivering or receiving power), or loads (for example, residential houses, commercial businesses, or the like).

Components of the electrical network 102, such as the transmission lines 110, the variable power generation assets 112, the substations 114, or the transformers 116, may inject energy or power (or assist in the injection of energy or power) into the electrical network 102. Each component of the electrical network 102 may be represented by any number of nodes in a network representation of the electrical network. The variable power generation assets 112 may be or include solar panels, wind turbines, or any other power generation device or system that produces power on an intermittent or variable basis, such as tidal power generators and wave power generators. The electrical network 102 may include a wide electrical network grid (for example, with 40,000 assets or more). Each electrical asset of the electrical network 102 may represent one or more elements of their respective assets. For example, the transformers 116, as shown in FIG. 1 may represent any number of transformers that make up electrical network 102.

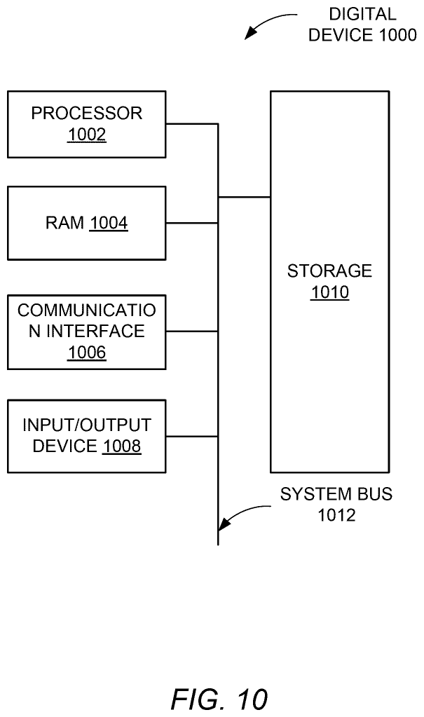

The variable power generation failure prediction system 104 may be or include any number of digital devices configured to predict failures of the variable power generation assets 112. Digital devices are discussed, for example, with reference to FIG. 10. In some embodiments, the variable power generation failure prediction system 104 may receive monitoring data, such as sensor data (e.g., SCADA, non-SCADA, or a combination of SCADA and non-SCADA data) from any number of electrical assets, operational alarms, event data, and/or production data of the variable power generation assets 112. The variable power generation failure prediction system 104 may also receive manufacturer data from the manufacturer data system 118 (or any source(s)). The variable power generation failure prediction system 104 may process such data to predict failures of the variable power generation assets 112.

The power system 106 may be or include any number of digital devices configured to control distribution or transmission of energy. The power system 106 may, in various examples, be controlled by a power company, utility, or the like.

The manufacturer data system 118 may be or include any number of digital devices configured to provide manufacturer data. The manufacturer data system 118 may, in various examples, be operated by a manufacturer or distributor of variable power generation assets or by a manufacturer or distributor of components or subcomponents (for example, gearboxes or gearbox bearings of wind turbines) of variable power generation assets. Although only a single manufacturer data system 118 is shown, there may be any number of manufacturer data systems that may be unrelated to each other that may provide manufacturing data. The manufacturing data received by the variable power generation failure prediction system 104 may be received from any number of any number of systems and combined to create a corpus of manufacturing data. The “manufacturing data” discussed herein may be received from any source or combination of sources (e.g., one or more different component manufacturers).

The operations system 120 may be or include any number of digital devices configured to operate or monitor the variable power generation assets 112. The operations system 120 may receive alerts or notifications including high risk identifications or failure predictions from the variable power generation failure prediction system 104. In some embodiments, the operations system 120 may then provide such information to the power system 106 or other systems that utilize high risk identifications or failure predictions for variable power generation assets 112. In various examples, the operations system 120 may be controlled by an operator of the variable power generation assets 112, a service provider, a maintenance service provider, an owner, and/or the like.

In some embodiments, the communication network 108 may represent one or more computer networks (for example, local area networks (LANs), wide area networks (WANs), or the like). The communication network 108 may provide communication between any of the variable power generation failure prediction system 104, the power system 106, the manufacturer data system 118, the operations system 120, or the electrical network 102. In some implementations, the communication network 108 comprises computer devices, routers, cables, or other network topologies. In some embodiments, the communication network 108 may be wired or wireless. In various embodiments, the communication network 108 may comprise the Internet, one or more networks that may be public, private, IP-based, non-IP based, and so forth.

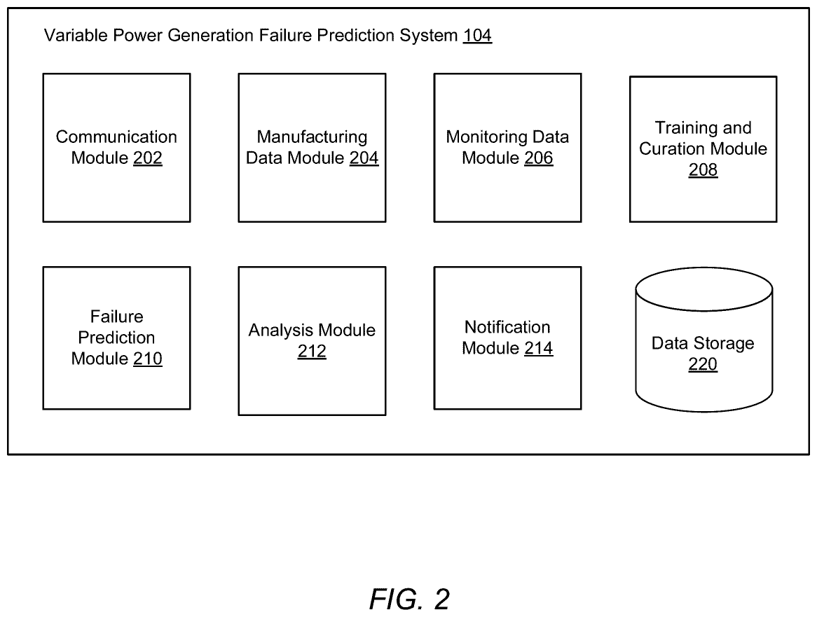

FIG. 2 depicts a block diagram of the variable power generation failure prediction system 104 in some embodiments. The variable power generation failure prediction system 104 includes a communication module 202, a manufacturing data module 204, a monitoring data module 206, a training and curation module 208, a failure prediction module 210, an analysis module 212, a notification module 214, and a data storage 220.

The communication module 202 may send or receive requests or data between the variable power generation failure prediction system 104 and any of the power system 106, the manufacturer data system 118, the operations system 120, and the electrical network 102. The communication module 202 may receive requests or data from the power system 106, the manufacturer data system 118, the operations system 120, or the electrical network 102. The communication module 202 may also send requests or data to the power system 106, the manufacturer data system 118, the operations system 120, or the electrical network 102.

The manufacturing data module 204 may receive manufacturing data, such as manufacturing data received from the manufacturer data system 118 and process the manufacturing data. For example, the manufacturing data module 204 may normalize manufacturing data, process certain manufacturing data to generate other manufacturing data, generate features from the manufacturing data, or perform other actions on the manufacturing data.

In some embodiments, the manufacturing data module 204 may identify manufacturing variables in the manufacturing data and sort each manufacturing variable based on dimension (e.g., size) or any other metric.

The monitoring data module 206 may receive monitoring data, such as monitoring data received from the electrical network 102 or the operations system 120, and process the monitoring data. For example, the monitoring data module 206 may normalize monitoring data, process certain monitoring data to generate other monitoring data, or perform other actions on the monitoring data. Monitoring data may include, for example, heat at or within a gearbox or a component connected to the gearbox. In another example, the monitoring data may include vibration, heat at or within a gearbox or a component connected to the gearbox. Heat and vibration are examples of operational stressors that may stress the operation of a component, a gearbox, and/or the wind turbine. In this example, heat generated by components of the gearbox and/or heat of the environment may impact performance (e.g., creating non-standard performance), signal potential failure, or indicate failure). In various embodiments, an operational stressor may refer to a quality (e.g., heat) and an operational stressor value refers to a quantifiable measure of the operational stressor (e.g., amount of heat such as 80 degrees Celsius).

The training and curation module 208 may train artificial intelligence or machine learning systems (for example, neural networks, sets of decision trees, etc.) to be applied to various types of data (for example, manufacturing data and monitoring data) to generate forecasts and/or predictions (for example, failure predictions or identifications of high risk variable power generation assets).

A machine learning model (which may be referred to as a model herein) may be one of a plurality of models. In some embodiments, there is a different model for each wind turbine or different type of wind turbine. For example, each model of the plurality of models may be for a different wind turbine. The model may include or be an XGBoost based learning model. It will be appreciated that the model may be or include other types of models or approaches (e.g., decision trees, random forests, GMM, and/or the like).

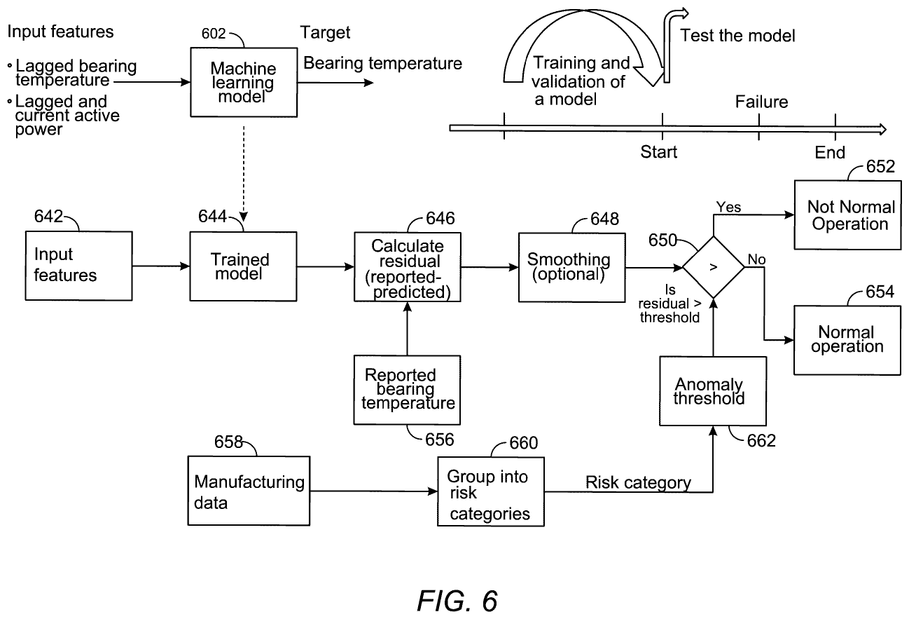

In various embodiments, the training and curation module 208 may train and validate a machine learning model to predict an operational stressor value based on sensor data from any number of wind turbines. Sensor data may be SCADA data, non-SCADA data (e.g., from other sensors), or a combination of SCADA and non-SCADA data. In one example, as discussed with regard to FIG. 6, a machine learning model may be trained using SCADA data of lagged bearing temperature and lagged and current active power to predict a bearing temperature (e.g., temperature at or near a bearing in a gearbox). A “lagged bearing temperature” in this example refers to the temperature measurement of a bearing that is recorded or analyzed after a delay, rather than in real-time. This delay or lag can be due to the method of data collection, processing times, or the specific setup of the monitoring system. A “lagged and current active power” in this example refers to a real-time measurement of power that the wind turbine is actively generating and a lagged active power refers to the active power data recorded at a previous time and potentially analyzed after a delay.

The failure prediction module 210 may apply artificial intelligence or machine learning systems to various types of data (for example, manufacturing data and monitoring data) to generate forecasts and/or predictions (for example, failure predictions or identifications of high risk variable power generation assets). In various embodiments, the failure prediction module 210 utilizes manufacturing survivability analysis and/or operational survivability analysis to determine if certain ranges of a manufacturing variable (e.g., a percentile of sorted dimension sizes of the manufacturing variable) are at risk of failure over time relative to other ranges of the manufacturing variable (e.g., relative to other percentiles of sorted dimension sizes of the manufacturing variable). A component or variable power generation asset that includes a component with a manufacturing variable of the high risk percentile range may be identified as a high risk (e.g., as being in a high risk category).

The failure prediction module 210 may generate different anomaly thresholds for comparing stressor values to assess if the component(s) are functioning inappropriately or potentially failing.

The analysis module 212 may analyze and process data. For example, the analysis module 212 may analyze manufacturing data for components of variable power generation assets and group the components based on the analysis. In some embodiments, the analysis module 212 selects the appropriate anomaly threshold based on whether a particular wind turbine includes a component with a manufacturing variable of the percentile of manufacturing variables determined to be at risk (e.g., as identified by the failure prediction module 210).

The notification module 214 may generate and provide notifications that include failure predictions generated by the failure prediction module 210. The notification module 214 may provide reports, alerts, and/or dashboards that include results, confidence scores, and/or other information.

The data storage 220 may include data stored, accessed, or modified by any of the machine learning modules of the variable power generation failure prediction system 104, such as the models described herein. The data storage 220 may include any number of data storage structures such as tables, databases, lists, or the like. In various embodiments, all data received, assessed, generated, and/or compared to anomaly thresholds may be stored to allow for auditing. Further, indications of notifications or alarms may be further stored with or without the notifications or alarms themselves.

A module may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, or any combination. Software may be executed by one or more processors. Although a limited number of modules are depicted in FIG. 2, there may be any number of modules. Further, individual modules may perform any number of functions, including functions of multiple modules as shown herein.

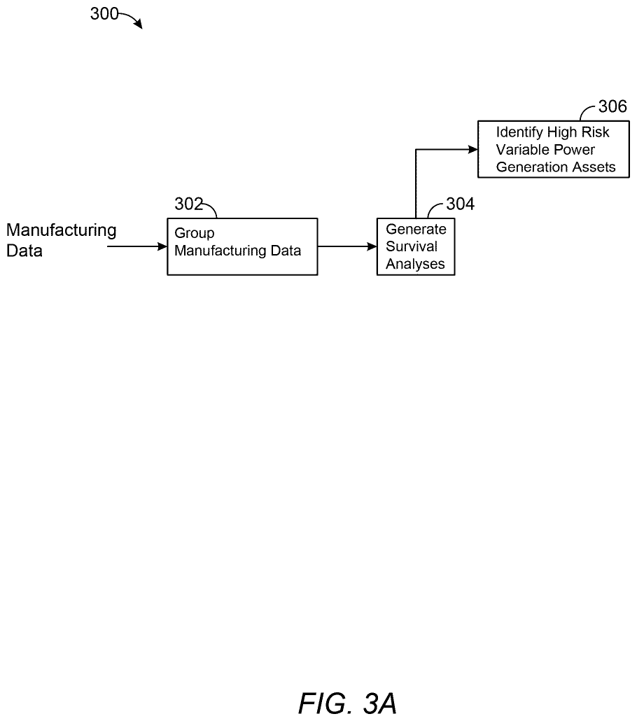

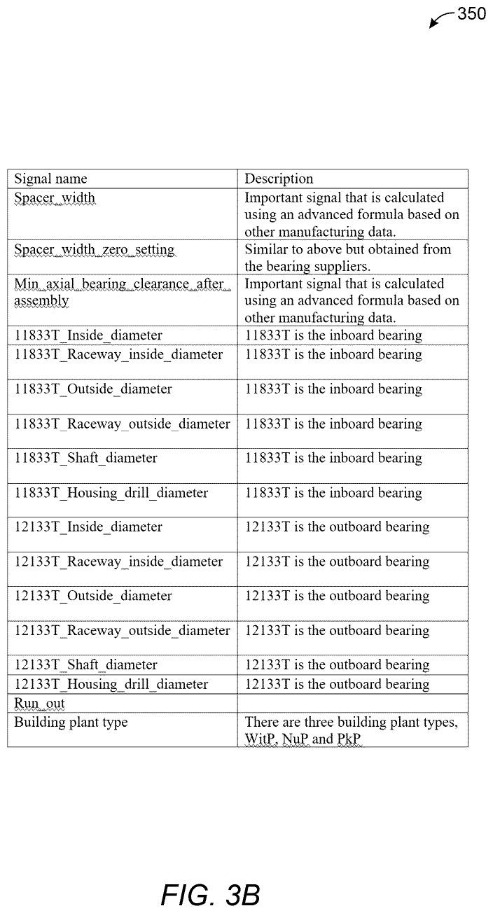

FIG. 3A is a flow diagram depicting a method 300 for identifying high risk variable power generation assets or predicting failures of variable power generation assets according to some embodiments. The variable power generation failure prediction system 104 (for example, various modules of the variable power generation failure prediction system 104) may perform the method 300. The method begins at step 302 where the variable power generation failure prediction system 104 groups manufacturing data that the variable power generation failure prediction system 104 has received (for example, from the manufacturer data system(s) 118).

As discussed herein, manufacturing data may be grouped by manufacturing variables. For a particular manufacturing variable (e.g., housing drill diameter), the dimensions of the variable (e.g., the diameter) may be sorted and broken into percentiles (e.g., the smallest range of diameters are from the 0-15^{th} percentile of the total range of dimensions).

In some embodiments, the manufacturing data may also be grouped by component type, manufacturer, hardware version, subcomponent(s), and/or equipment that particular components belong to (e.g., a set of components may be grouped by belonging to a general or type of gearbox). FIG. 3B depicts Table 350 which includes examples of manufacturing variables from manufacturing data that may be utilized by the variable power generation failure prediction system 104 in some embodiments.

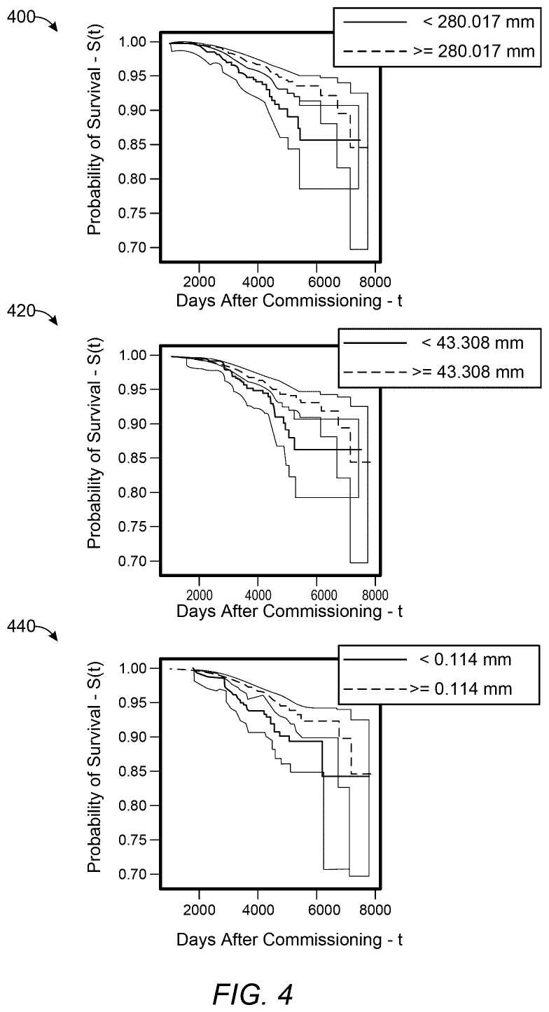

Returning to FIG. 3A, at step 304, the variable power generation failure prediction system 104 generates one or more manufacturing survival analyses for one or more components of multiple variable power generation assets based on the manufacturing data. As will be described in more detail herein, the failure prediction module 210 may perform a manufacturing survivability analysis on different percentile ranges of a particular manufacturing variable from the manufacturing data. As previously discussed, dimensions or values of a particular manufacturing variable may be sorted based on size or quality. As a result, certain sets of dimensions or values represent a percentile of the dimensions or values in the manufacturing data for that particular manufacturing variable. The manufacturing survivability analysis tracks historical data of failures over time to identify certain percentile ranges that fail more often as compared to other percentile ranges of the same manufacturing variable. In some embodiments, percentile ranges that fail more often may selected on the basis of p-value or a statistical significance evaluation to determine the significance of the finding. FIG. 4 depicts manufacturing survivability analysis plots as discussed herein.

In step 306, the failure prediction module 210 may identify percentile ranges of manufacturing variables as high risk based on the manufacturing survivability analysis. In some embodiments, the failure prediction module 210 identifies a percentile range of manufacturing variables with significant failures as high risk based on a significantly low p-value (e.g., as compared to a p-value threshold) or other significance evaluation.

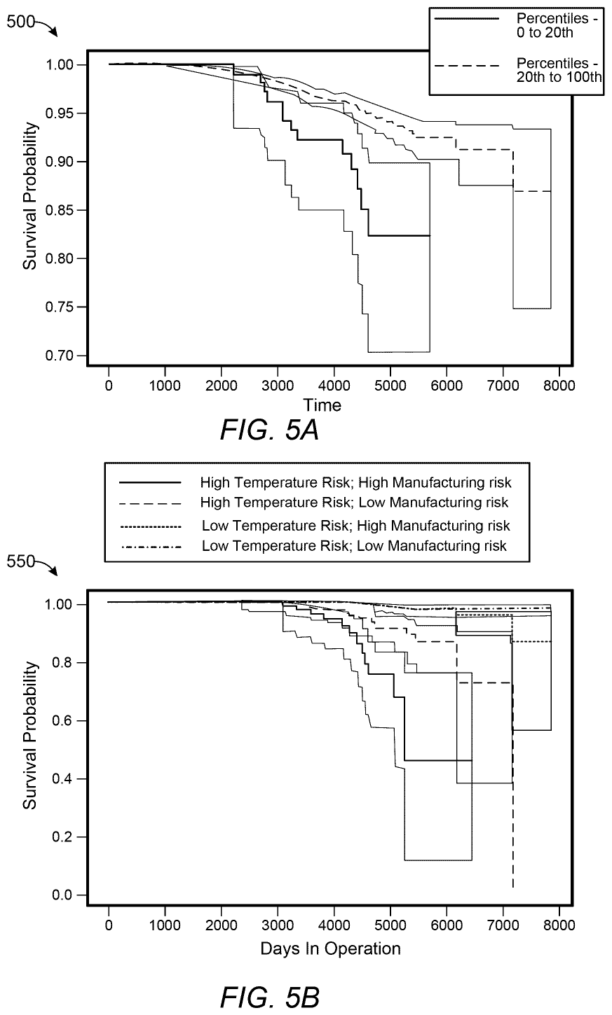

Alternately, in various embodiments, the failure prediction module 210 may perform an operational survivability analysis of one or more selected percentiles of one or more manufacturing variables (from the manufacturing survivability analysis) in the presence of an operational stressor (e.g., heat). The failure prediction module 210 may identify and select a series of selected percentile ranges of the manufacturing variable(s) that fail over time in the presence of the operational stressor based on historical data. In some embodiments, the failure prediction module 210 identifies a percentile range of manufacturing variables with significant failures in the operational survivability analysis as high risk based on a significantly low p-value (e.g., as compared to a p-value threshold) or other significance evaluation. FIGS. 5A and 5B depict operational survivability analysis plots as discussed herein.

Optionally, in some embodiments, the failure prediction module 210 may identify high risk variable power generation assets (e.g., high risk wind turbines) based on those that contain components that have the manufacturing variables that are in the selected percentile ranges (e.g., those identified as being significant as failing more often based on the manufacturing survivability analysis or based on a combination of the manufacturing survivability analysis and the operational survivability analysis). These components and variable power generation assets may be categorized as “high risk.”

Each of the selected percentiles may be associated with an anomaly threshold. In some embodiments, different selected percentiles of manufacturing variable(s) from the manufacturing survivability analysis and/or the operational survivability analysis may be associated with a different anomaly threshold. In some embodiments, two or more of the selected percentiles may be associated with the same anomaly threshold.

FIG. 4 depicts three survival analysis plots of a manufacturing variable of a variable power generation asset used in manufacturing survivability analysis in some embodiments. A first survival analysis plot 400 is for a univariate survival analysis of gearboxes of wind turbines grouped by percentiles according to the manufacturing variable “11833T Housing Drill Diameter.” The solid line represents failures in the first 0 to 20^{th} percentile of the gearboxes ranked by the manufacturing datum. The dashed line represents failures in the remaining 21 to 100^{th} percentile of the gearboxes ranked by the dimensions (e.g., size) of the manufacturing variable. The lighter weight lines may represent or be based on confidence intervals. The first survival analysis plot 400 depicts that there is a relevant distinction in survival curves between wind turbines of different groups. There is a good representation of wind turbines in both groups. The log-rank test (p-value) is 0.0022. In this example, there is a significant indication of failure in the 0-20^{th} percentile relative to the 21^{st}-100^{th} percentile. As such, the 0-20^{th} percentile may be selected or identified. In some embodiments, the manufacturing variable (the 11833T Housing Drill Diameter) of this range is determined to be “high risk.” Wind turbines that include this manufacturing variable may similarly be determined to be “high risk.”

A second survival analysis plot 420 is for a univariate survival analysis of gearboxes of wind turbines grouped by percentiles according to the manufacturing variable “Spacer Width.” The solid line represents failures in the first 0 to 20^{th} percentile of the gearboxes ranked by the dimensions of the manufacturing variable (e.g., width). The dashed line represents failures in the remaining 21^{st} to 100^{th} percentile of the gearboxes ranked by the manufacturing variable. The lighter weight lines may represent or be based on confidence intervals. The second survival analysis plot 420 depicts that there is a relevant distinction in survival curves between wind turbines of different groups. There is a good representation of wind turbines in both groups. The log-rank test (p-value) is 0.0163. In this example, there is a significant indication of failure in the 0-20^{th} percentile relative to the 21^{st}-100^{th} percentile. As such, the 0-20^{th} percentile may be selected or identified. In some embodiments, the manufacturing variable (the Spacer Width) of this selected or identified range is determined to be “high risk.” Wind turbines that include this manufacturing variable may similarly be determined to be “high risk.”

A third survival analysis plot 440 is for a univariate survival analysis of gearboxes of wind turbines grouped by percentiles according to the manufacturing datum Axial Clearance Reduction after Assembly. The solid line represents failures in the first 0 to 20^{th} percentile of the gearboxes by the dimensions of the manufacturing variable (e.g., clearance). The dashed line represents failures in the remaining 21^{st} to 100^{th} percentile of the gearboxes ranked by the manufacturing variable. The lighter weight lines may represent or be based on confidence intervals. The third survival analysis plot 440 depicts that there is a relevant distinction in survival curves between wind turbines of different groups. There is a good representation of wind turbines in both groups. The log-rank test (p-value) is 0.0123. In this example, there is a significant indication of failure in the 0-20^{th} percentile relative to the 21^{st}-100^{th} percentile. As such, the 0-20^{th} percentile may be selected or identified. In some embodiments, the manufacturing variable (the Axial Clearance Reduction after Assembly) of this range is determined to be “high risk.” Wind turbines that include this manufacturing variable may similarly be determined to be “high risk.”

Although all three plots indicated that the 0-20^{th} percentile is positively related with failure relative to other percentiles, any percentile may be positively related with failure. Similarly, different manufacturing variables may have different percentiles associated with failure. As will be understood, some manufacturing variables may have different percentiles associated with failure but it is not sufficiently significant and, as such, may not be identified as “high risk.”

For each of the three survival analyses, the log-rank test indicates that the resulting distinction between gearbox populations at lower and higher risk of failure is statistically significant.

FIG. 5A depicts a manufacturing survival analysis plot 500 for a bivariate survival analysis of gearboxes of wind turbines grouped by percentiles according to the manufacturing variables “Spacer Width” and “11833T Housing Drill Diameter” in some embodiments.

The solid line represents failures in the first 0 to 20^{th} percentile of the manufacturing variables ranked by the manufacturing data. The dashed line represents failures in the remaining 21^{st} to 100^{th} percentile of manufacturing variables ranked by the manufacturing data. The solid line represents 13 failures out of a total of 106 failures among 1980 gearboxes in the data set. The lighter weight lines may represent or be based on confidence intervals.

FIG. 5B depicts an operational survival analysis plot 550 for a survival analysis for a component of a variable power generation asset in the presence of heat in some embodiments. The survival analysis plot 550 is for a bivariate survival analysis of gearboxes of wind turbines grouped by percentiles according to the manufacturing variable “Spacer Width” and the operational stressor being bearing temperature (e.g., temperature caused by the bearing and/or environmental heat). The manufacturing datum “Spacer Width” is for an indicator of high manufacturing risk (0 to 20^{th} percentile of spacer width) and the operational stressor being bearing temperature is for an indicator of operational risk (80^{th} to 100^{th} percentile of 1-month average of bearing temperature). The operational survival analysis plot 550 indicates that the addition of constant manufacturing data to dynamic monitoring data allows better identification of manufacturing variables as well as gearboxes that have components with those operational variables associated with a (e.g., statistically significant) risk of failure without an operational stressor or risk of failure (e.g., statistically significant) in the presence operational stressor.

In this example, “bearing temperature” refers to the operating temperature of a bearing within a gearbox of a wind turbine. Bearings are crucial components that allow for smooth rotation and movement of parts within machinery.

Without being bound by any particular theory, the connection between spacer width and bearing temperature may be understood in the following terms: bearing clearance is sensitive to spacer width, and deviation from optimum bearing clearance increases friction and raises bearing temperature. Using spacer width to identify a population at high risk, and with more extensive monitoring data, it should be possible to study the time dependence of the rise in temperature and learn more about this path to failure. The survival analyses depicted in FIG. 4 through FIG. 5B illuminates the interplay between various manufacturing and operational risk factors that can lead to failure of wind turbines.

FIG. 6 depicts methods for identifying high risk variable power generation assets or components according to some embodiments. As discussed herein, the training and curation module 208 may train one or more models to identify non-standard sensor data (e.g., anomalies). Step 602 of FIG. 6 depicts an approach to training machine learning models to identify or predict bearing temperature in some embodiments. Although FIG. 6 depicts a machine learning model receiving specific inputs to predict a specific output (e.g., a bearing temperature), it will be appreciated that the machine learning model may be trained to receive different inputs (e.g., different sensor data) and predict different outputs (i.e., the machine learning model may be trained to predict one or more different operational stressors of different components and is not limited to only predicting bearing temperature).

In step 602, a machine learning model is trained using normal monitoring data (i.e., healthy operation) to predict bearing temperature. The input features used in this example are lagged bearing temperature and lagged and current active power. In some embodiments, the machine learning model may be trained to minimize the residual (i.e., the difference between the estimated bearing temperature and actual bearing temperature) or trained to learn statistical data distribution during normal operation.

As discussed herein, in some embodiments, the training and curation module 208 receives sensor data from one or more wind turbines operating under healthy conditions. As discussed herein, the sensor data may be lagged rotor speed, current wind speed, lagged wind speed, and pitch angle data. While lagged rotor speed, current wind speed, lagged wind speed, and pitch angle data are discussed herein, it will be appreciated that any sensor data may be utilized.

The training and curation module 208 may train a model based on these input features to provide a target rotor speed. As discussed herein, the training and curation module 208 may train a model based on input features to provide any target performance metric (e.g., not limited to bearing temperature). Further, any model may be utilized in conjunction with the systems and methods described herein.

Models for anomaly detection are created and validated using different approaches. In one example, example, models may be created and/or validated using two approaches 1) GMM and/or 2) XGBoost based machine learning model. In some embodiments, the XGBoost model is implemented as follows: Python XGBoost library is used for the training, which requires each input predictor to be a column in a python dataframe. In one example, there may be an XGBoost model for each wind turbine. In one example, the following hyper-parameters are examples shown in Table I below.

TABLE I
HYPER-PARAMETERS OF THE XGBOOST MODEL

| | |
|---|---|
| n estimators | 1000 |
| max depth | 5 |
| learning rate | 0.01 |
| subsample | 1 |
| colsample bytree | 0.8 |

In one example, the training and curation module 208 may train the machine learning model to predict the bearing temperature using the lagged bearing temperature and the lagged and current active power on a particular wind turbine (e.g., historical data) or a plurality of wind turbines.

FIG. 6 also depicts a graph showing the validation and testing of the model in some embodiments. The model may be validated against known historical data of healthy wind turbines by comparing the target bearing temperature (and/or any other outputs of the model) to sensor readings of healthy performance over time (e.g., actual bearing temperature as provided by sensor readings). In some embodiments, the model may also be validated against historical data of wind turbines that are damaged, failing, or have failed.

The performance of the model may be evaluated. In one example, the performance of the performance of the model is evaluated using the following metrics. The recall is calculated as follows:

$$Recall = \frac{T P}{T P + F N}$$

Where TP is the true positive cases (i.e., damaged turbines that are correctly alerted) and FN is the false negative cases (i.e., damaged turbines that are not alerted). The precision is calculated using:

$$Precision = \frac{T P}{T P + F P}$$

Where FP is the false positive cases (i.e., false alerts from the approach). The F1-score is given by:

$$F 1 - score = \frac{2 * Recall * Precision}{Recall + Precision}$$

Once a model is created and verified, the model may be used to generate a predicted sensor measurement (e.g., bearing temperature) for comparison to actual bearing temperature using sensor measurements from the particular wind turbine.

Returning to FIG. 6, in step 642, the communication module 202 receives and/or retrieves input features. In various embodiments, the communication module 202 receives sensor data (e.g., SCADA data and/or other sensor data) of a particular wind turbine.

The sensor measurements may be processed or otherwise assessed to retrieve or generate features for input to the trained model in step 644. In this example, the measurements may be used as features or generated into features that are related to bearing temperature. It will be appreciated that any number of features may be provided to the trained model. Further, any number of features may be engineered or created based on sensor measurements from the wind turbine and provided to the trained model. The engineered and/or created features may be provided in addition to or instead of any sensor measurements. The trained model may provide an estimate of bearing temperature based on the input features.

In step 656, the analysis module 212 may receive the reported bearing temperature. The reported bearing temperature may be of the wind turbine or component(s) of the wind turbine. It will be appreciated that this may be any stressor value measured at the wind turbine or component. The stressor value may be received or generated from monitoring data from the wind turbine. The stressor value, in various embodiments, is the same stressor (but potentially different value) as that predicted by the machine learning module.

In step 646, the analysis module 212 may compare the estimated bearing temperature from the model to the actual or reported bearing temperature of the wind turbine. In various embodiments, in step 648, one or more sensors may report measurements of bearing temperature and that information may be provided to the communication module 202 and/or the analysis module 212. The measurements of bearing temperature and/or bearing temperature itself (e.g., determined by the wind turbine, sensor of the wind turbine, or SCADA service) may be compared to the estimated bearing temperature.

In one example, the comparison of the estimated bearing temperature from the model to the actual bearing temperature of the wind turbine (e.g., the difference) creates a residual value. In some embodiments, the residual is expected to increase if the wind turbine is damaged, failing, or failed (e.g., one or more of the components of the wind turbine, such as a component of the gearbox of a wind turbine) are damaged, failing, or failed.

In optional step 648, the comparison of the estimated bearing temperature to the reported (or measured) bearing temperature (e.g., the residual) may be optionally smoothed by the analysis module 212. Smoothing the data may assist in determining if the comparison of the estimated bearing temperature to the reported (or measured) bearing temperature is within a predetermined anomaly threshold.

In step 650, the analysis module 212 may compare the calculated residual (e.g., estimated bearing temperature to the actual (or measured) bearing temperature) to the predetermined anomaly threshold.

Steps 658, 660, and 662 relate to selection and/or generation of an anomaly threshold. As discussed herein, the communication module 202 may receive manufacturing data in step 658. The manufacturing data may contain manufacturing variables for any number of components of a wind turbine. In step 660, one or more of the manufacturing variables are grouped together and sorted based on dimension (e.g., from least to greatest in size or any dimension) to assist in the analysis and identify one or more risk categories. For at least one of the grouped manufacturing variables, sets based on sorted dimensions (e.g., percentile ranges) may be evaluated using a manufacturing survivability analysis as described herein to identify high risk manufacturing variables (e.g., those manufacturing variables associated with failure over time relative to other percentiles of that data set from the manufacturing data) and, by extension, those wind turbine components that are manufactured with those high risk manufacturing variables may be similarly labeled as “high risk.”

FIG. 8 is an example of identifying high risk components in some embodiments in order to group components and/or variable power generation failure prediction systems into a high risk category in some embodiments. In step 802, the communication module 202 receives manufacturing data that includes manufacturing variables for different components of a plurality of variable power generation assets. As discussed herein, each manufacturing variable of the manufacturing data is or includes any number (e.g., a plurality) of dimensional metrics. In the example herein, a particular drill diameter may have a variety of different diameters. The manufacturing data may include a variety of different drill diameters for the same type of component.

In step 804, the manufacturing data module 204 may sort the plurality of dimensional metrics based on size. For example, every different drill diameter for the same type of component may be grouped and sorted based on size of the diameter.

In step 806, the failure prediction module 210 performs a manufacturing survivability analysis on different percentile ranges of the sorted dimensional metrics to determine manufacturing risk categories based, at least in part, on risk of failure over time. The manufacturing survivability analysis may utilize historical information of components that include a particular size of a manufacturing variable (e.g., a particular diameter of the drill diameter) and examine the probability of failure or probability of success over time.

In some embodiments, the manufacturing survivability analysis may utilize historical information of components that include a range of particular sizes of a manufacturing variable (e.g., particular diameters of the drill diameter) and examine the probability of failure or probability of success over time for that range relative to other ranges (e.g., the range representing a percentile of drill diameters sorted from smallest to largest). The failure prediction module 210 may perform statistical analysis (e.g., generate p-values) for significance. In some embodiments, the failure prediction module 210 may identify a percentile (e.g., a sorted range) of the manufacturing variable as being “high risk” by virtue of the probability of success (or failure) relative to other percentile ranges. In some embodiments, the failure prediction module 210 may identify a percentile (e.g., a sorted range) of the manufacturing variable as being “high risk” by virtue of the probability of success (or failure) relative to other percentile ranges for the same manufacturing variable as well as in comparison to risk of failure (e.g., using a manufacturing survivability analysis) of other manufacturing variables.

In some embodiments, the failure prediction module 210 performs a manufacturing survivability analysis of a combination of two or more manufacturing variables. For example, the failure prediction module 210 may receive or select two selected percentile ranges, each selected percentile range being of a different manufacturing variable. The failure prediction module 210 may perform a manufacturing survivability analysis of components that have those two manufacturing variables of those ranges (e.g., a component with a housing drill diameter within the 0-20^{th} percentile of housing drill diameters as well as a spacer width within the 21^{st}-40^{th} percentile spacer widths). In some embodiments, the failure prediction module 210 performs a separate analysis on each manufacturing variable (e.g., see above), select the ranges that are most at risk relative to other ranges of the same manufacturing variable, and then performs another manufacturing survivability analysis on both selected percentiles to see if they are more prone to fail over time (e.g., relative to other percentile ranges or not relative to other percentile ranges). If significant, the combination of manufacturing variables identified as prone to failure over time may be identified as high-risk percentiles of manufacturing variables.

In optional step 808, the failure prediction module 210 performs an operational survivability analysis on different percentile ranges of the sorted dimensional metrics to determine operational risk categories based, at least in part, on risk of failure over time in the presence of an operational stressor (e.g., bearing temperature). The operational survivability analysis may utilize historical information of components that include a particular size of a manufacturing variable (e.g., a particular diameter of the drill diameter) and examine the probability of failure or the probability of success over time in the presence of the operational stressor. The operational survivability analysis may evaluate one or more manufacturing variables over a range of operational stressors (e.g., from low to high bearing temperatures).

The failure prediction module 210 may perform statistical analysis (e.g., generate p-values) for significance. In some embodiments, the failure prediction module 210 may identify a percentile (e.g., a sorted range) of the manufacturing variable as being “high risk” by virtue of the probability of success (or failure) relative to other percentile ranges identified in the operational survivability analysis. In some embodiments, the failure prediction module 210 may identify a percentile (e.g., a sorted range) of the manufacturing variable as being “high risk” by virtue of the probability of success (or failure) relative to other percentile ranges for the same manufacturing variable as well as in comparison to risk of failure (e.g., using a manufacturing survivability analysis) of other manufacturing variables.

It will be appreciated that, in some embodiments, identification of high-risk percentile ranges of manufacturing variables are based on manufacturing survivability analysis (e.g., of one or more manufacturing variables). In various embodiments, identification of high-risk percentile ranges of manufacturing variables are based on operational survivability analysis without performing a manufacturing survivability analysis.

In other examples, the identification of high-risk percentile ranges of manufacturing variables are based on both manufacturing survivability analysis and operational survivability analysis. For example, a percentile of a manufacturing variable may be identified by a manufacturing survivability analysis as being prone to failure. The failure prediction module 210 may then perform an operational survivability analysis using that particular percentile of the manufacturing variable in the presence of an operational stressor (or a range of the operational stressor from low to high). In some embodiments, the failure prediction module 210 may perform an operational survivability analysis using the particular percentile of the manufacturing variable in the presence of different operational stressors (e.g., heat of a particular component, vibration of a particular component, and/or the like).

In step 810, the analysis module 212 identifies high-risk components of variable power generation asset(s) as having one or more manufacturing variables associated with failure based on manufacturing survivability analysis and/or operational survivability analysis. For example, the analysis module 212 may identify components and/or wind turbines that have manufacturing variables that are labeled as high risk. Those components and/or wind turbines may be similarly labeled as “high risk.”

The analysis module 212 may further identify anomaly thresholds based on components or wind turbines as being high risk. For example, a component or wind turbine that does not contain any components with manufacturing variables identified as “high risk” as per the process(es) above, may be associated with a first anomaly threshold (e.g., a default anomaly threshold) or no anomaly threshold. Based on the degree and likelihood of failure indicated by the manufacturing survivability analysis and/or the operational survivability analysis, an anomaly threshold (e.g., a second anomaly threshold) may be generated for components or wind turbines identified as being high-risk (e.g., the anomaly threshold being tighter if the manufacturing variable of a particular component has historically been found to fail earlier either with or without the presence of an operational stressor).

In step 662, the analysis module 212 may select an anomaly threshold based on the wind turbine that provided the input features in step 642. The analysis module 212 may identify the particular wind turbine that provided in the input features in step 642 of FIG. 6 and may determine that the particular has one or more components within the percentile ranges of manufacturing variables considered to be “high risk.” If so, the analysis module 212 may select an anomaly threshold from a plurality of anomaly thresholds based on the particular wind turbine or based on the presence of the component within the percentile range of the manufacturing variable(s) considered to be “high risk” (e.g., based on manufacturing survivability analysis and/or operational survivability analysis).

In step 650, the variable power generation failure prediction system 104 determines if the difference calculated at step 646 (and optionally smoothed at step 648) is outside the selected anomaly threshold. If the variable power generation failure prediction system 104 determines that the difference exceeds the particular anomaly threshold, the method proceeds to step 652 where the variable power generation failure prediction system 104 determines that the particular variable power generation asset is not operating normally. If the variable power generation failure prediction system 104 determines that the difference does not exceed the particular anomaly threshold, the method proceeds to step 654 where the variable power generation failure prediction system 104 may take no action. While FIG. 6 states “normal operation,” it will be appreciated that no such conclusion may be determined based on the process of FIG. 6.

The variable power generation failure prediction system 104 may generate, based on determining that the particular variable power generation asset is not operating normally or on determining that the particular variable power generation asset is operating normally, an operation indication for the particular variable power generation asset. The variable power generation failure prediction system 104 may provide the operation indication (e.g., a notification or alert) for the particular variable power generation asset, such as to, for example, the operations system 120 or the power system 106.

The methods depicted in FIG. 6 may follow from a conjecture (without being bound to any particular theory) that a component temperature is different for different risk categories and therefore, the alert threshold should take risk category into consideration. It is believed that operational high-risk categories have higher temperatures before a failure. One example would be high risk categories that have higher operational temperatures so having a high alert threshold for this category can get rid of some of the false positives and therefore increase precision. Similarly, low risk categories could use a lower value for the alert threshold. This new step should help reduce false alarms from the temperature anomaly detection approach (for example, improve precision) and potentially improve recall.

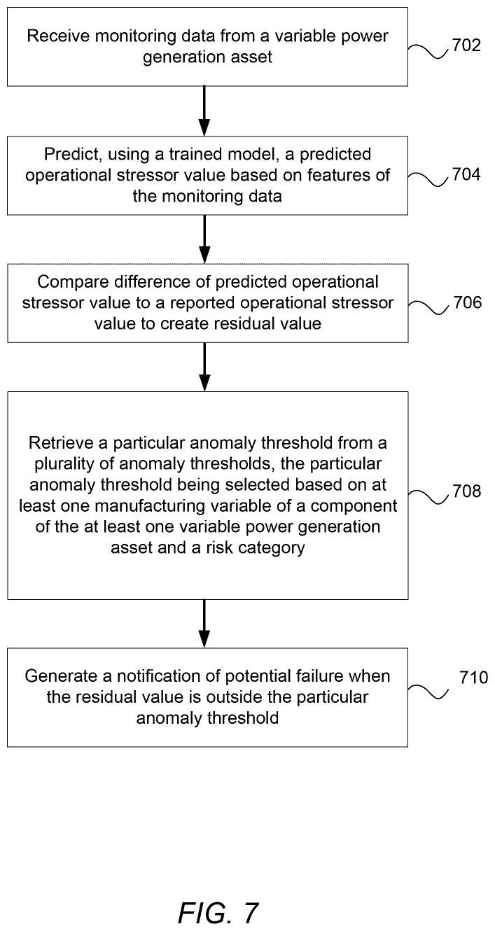

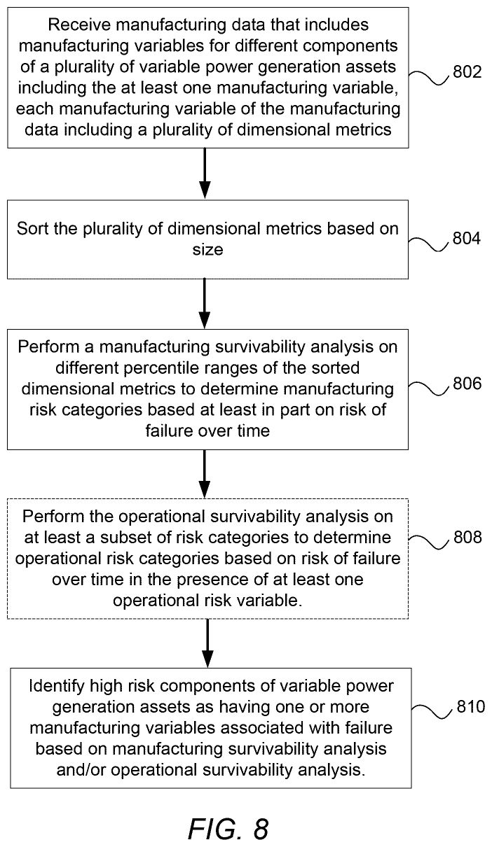

FIG. 7 is a flow diagram depicting an example method that is an embodiment of the method depicted in FIG. 6. In step 702, the communication module 202 receives monitoring data from a variable power generation asset. The monitoring data may include SCADA and/or non-SCADA data. The monitoring data may also include or not include operational alerts.

In step 704, the failure prediction module 210 predicts, using a trained model, a predicted operational stressor value based on features of the monitoring data. Features may include, for example, lagged bearing temperature and lagged and current active power. The operational stressor value may be a value associated with, in this example, a degree of bearing temperature. It will be appreciated that the model may be trained to predict any value (e.g., vibration, temperature, or the like for a single component or a combination of components).

In step 706, the analysis module 212 compares a difference of the predicted operational stressor value to a reported operational stressor value (e.g., based on monitoring data received from the variable power generation asset with or outside of step 702) to create a residual value.

In step 708, the analysis module 212 retrieves a particular anomaly threshold from a plurality of anomaly thresholds. The analysis module 212 may select the particular anomaly threshold based on at least one manufacturing variable of a component of the variable power generation asset and a risk category (e.g., the component having a manufacturing variable within a percentile that is considered to be “high risk” as discussed herein). In some embodiments, the analysis module 212 may select the particular anomaly threshold based on at least one manufacturing variable of a component of the variable power generation asset and a risk category (e.g., the component having a manufacturing variable within a percentile that is considered to be “high risk” as discussed herein) based on an operational survivability analysis over time for that at least one manufacturing variable in a presence of the operational stressor (e.g., the same operational stressor as that predicted by the machine learning model). In this example, the operational survivability analysis may be performed over a range of operational stressor values for the same operational stressor.

In step 710, the notification module 214 may generate a notification of a potential failure or failing component when the residual value is outside the selected, particular anomaly threshold.

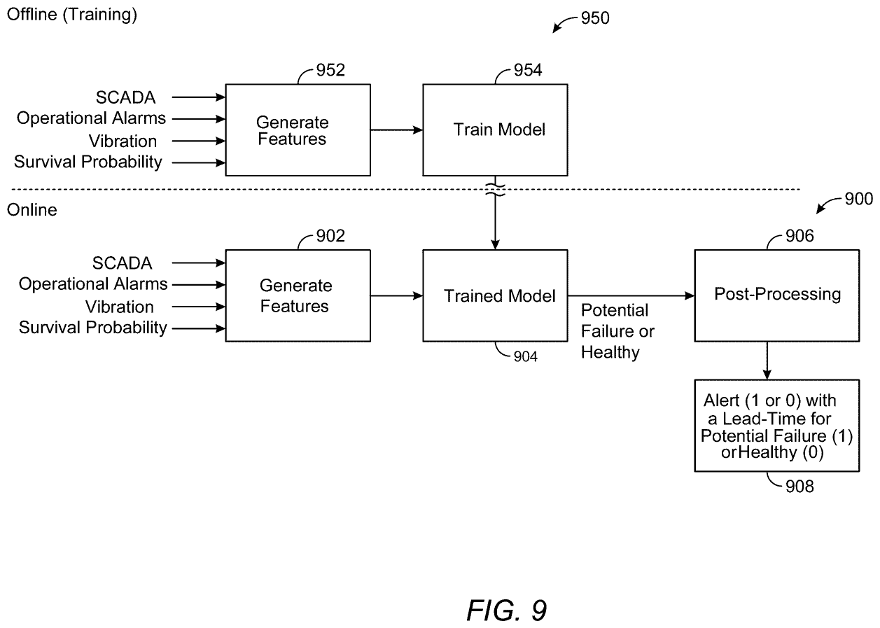

FIG. 9 is a flow diagram depicting a method 900 for predicting failure of variable power generation assets and a method 950 for training a model that may be utilized by the variable power generation failure prediction system 104 to predict failures, according to some embodiments. The method 950 begins at step 952 where the variable power generation failure prediction system 104 receives SCADA data, operational alarm data, and sensor data for multiple variable power generation assets. For example, the variable power generation failure prediction system 104 may receive sensor data such as vibration data for gearboxes of wind turbines. The variable power generation failure prediction system 104 also receives survival probabilities for multiple components of the multiple variable power generation assets.

The survival probabilities may be based on survival analyses. The variable power generation failure prediction system 104 may generate the survival analyses for the components based on manufacturing data and historical failure data. The variable power generation failure prediction system 104 may then determine survival probabilities based on the survival analyses.

Also at step 952 the variable power generation failure prediction system 104 generates features based on monitoring data such as the SCADA data, the operational alarm data, and the sensor data, as well as, in some embodiments, survival probabilities. At step 954 the variable power generation failure prediction system 104 trains a model (for example, an artificial intelligence or machine learning model such as a neural network, decision-tree based model, XGBoost, GMM, and/or the like) on the features.

The method 900 begins at step 902 where the variable power generation failure prediction system 104 receives SCADA data, operational alarm data, sensor data, and survival probabilities for a variable power generation asset. Also at step 902 the variable power generation failure prediction system 104 generates features based on the SCADA data, the operational alarm data, the sensor data, and the survival probabilities. At step 904 the variable power generation failure prediction system 104 applies the trained model to the features to obtain a failure prediction for the variable power generation asset. At step 906 the variable power generation failure prediction system 104 may perform post-processing, such as generating a failure prediction confidence based on the output of the trained model or a lead time to failure of the variable power generation asset. At step 908 the variable power generation failure prediction system 104 generates, based on the failure prediction, an alert, and provides the alert, such as to, for example, the operations system 120 or the power system 106. The alert may include an identification of the variable power generation asset, a severity of the alert (for example, based on the confidence or the lead time), and the lead time to failure. The use of survival probability in the method 900 is expected to further improve the accuracy of failure predictions of variable power generation assets.

FIG. 10 depicts a block diagram of an example digital device 1000 according to some embodiments. The digital device 1000 is shown in the form of a general-purpose computing device. The digital device 1000 includes at least one processor 1002, RAM 1004, communication interface 1006, input/output device 1008, storage 1010, and a system bus 1012 that couples various system components including storage 1010 to the at least one processor 1002. A system, such as a computing system, may be or include one or more of the digital device 1000.

System bus 1012 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1000 typically includes a variety of computer system readable media, such as computer system readable storage media. Such media may be any available media that is accessible by any of the systems described herein, and it includes both volatile and nonvolatile media and removable and non-removable media.

In some embodiments, the at least one processor 1002 is configured to execute executable instructions (for example, programs). In some embodiments, the at least one processor 1002 comprises circuitry or any processor capable of processing the executable instructions.

In some embodiments, RAM 1004 stores programs or data. In various embodiments, working data is stored within RAM 1004. The data within RAM 1004 may be cleared or ultimately transferred to storage 1010, such as prior to reset or powering down the digital device 1000.

In some embodiments, the digital device 1000 is coupled to a network, such as the communication network 108, via communication interface 1006. The digital device 1000 can communicate with one or more networks such as a local area network (LAN), a general wide area network (WAN), or a public network (for example, the Internet).

In some embodiments, input/output device 1008 is any device that inputs data (for example, mouse, keyboard, stylus, sensors, etc.) or outputs data (for example, speaker, display, virtual reality headset).

In some embodiments, storage 1010 can include computer system readable media in the form of non-volatile memory, such as read only memory (ROM), programmable read only memory (PROM), solid-state drives (SSD), flash memory, or cache memory. Storage 1010 may further include other removable/non-removable, volatile/non-volatile computer system storage media. By way of example only, storage 1010 can be provided for reading from and writing to a non-removable, non-volatile magnetic media. The storage 1010 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1012 by one or more data media interfaces. As will be further depicted and described below, storage 1010 may include at least one program product having a set (for example, at least one) of program modules that are configured to carry out the functions of embodiments of the invention. In some embodiments, RAM 1004 is found within storage 1010.

Programs/utilities, having a set (at least one) of program modules, such as the property layout system, may be stored in storage 1010 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the invention as described herein.

It should be understood that although not shown, other hardware or software components could be used in conjunction with the digital device 1000. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations or block diagrams of methods, apparatus (systems) and computer program products according to embodiments of the invention. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “and/or” in this disclosure is not intended to be understood as an exclusive “or.” Rather, “or” is to be understood as including “or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. Therefore, variations of the example embodiments are intended to be covered by the disclosure herein.

1. A non-transitory computer-readable medium comprising executable instructions, the executable instructions being executable by one or more processors to perform a method, the method comprising:
receiving monitoring data from at least one variable power generation asset;
predicting, using a trained machine model, a predicted operational stressor value based on features of the monitoring data, the operational stressor value being a stressor metric of an operational stressor of a condition of at least a part of the at least one variable power generation asset;
comparing a difference of the predicted operational stressor value to a reported operational stressor value to create a residual value, the reported operational stressor value having been being based on a measurement of the reported operational stressor value of the at least one variable power generation asset;
retrieving a particular anomaly threshold from a plurality of anomaly thresholds, the particular anomaly threshold being selected based on at least one manufacturing variable of a component of the at least one variable power generation asset and a risk category that is based on an operational survivability analysis over time for that at least one manufacturing variable in a presence of the operational stressor, the at least one manufacturing variable being from manufacturing data; and
providing a notification of potential failure when the residual value is outside the particular anomaly threshold.

2. The non-transitory computer-readable medium of claim 1, further comprising:
receiving the manufacturing data that includes manufacturing variables for different components of a plurality of variable power generation assets including the at least one manufacturing variable, each manufacturing variable of the manufacturing data including a plurality of dimensional metrics;
for each manufacturing variable:
sorting the plurality of dimensional metrics based on size;
performing a manufacturing survivability analysis on different percentile ranges of the sorted dimensional metrics to determine manufacturing risk categories based at least in part on risk of failure over time; and
performing the operational survivability analysis on at least a subset of risk categories to determine operational risk categories based on risk of failure over time in the presence of at least one operational risk variable.

3. The non-transitory computer-readable medium of claim 2, wherein performing the manufacturing survivability analysis on the different percentile ranges of the sorted dimensional metrics to determine the manufacturing risk categories based at least in part on the risk of failure over time comprises determining at least one first p-value to determine significance of the different percentile ranges of the sorted dimensional metrics, at least one manufacturing risk category being determined based, at least in part, on the first p-value being sufficiently low.

4. The non-transitory computer-readable medium of claim 2, wherein performing the operational survivability analysis on at least the subset of risk categories to determine the operational risk categories based on the risk of failure over time in the presence of at least one operational risk variable comprises determining at least one second p-value to determine significance of the different operational risk categories, at least one operational risk category being determined based, at least in part, on the second p-value being sufficiently low.

5. The non-transitory computer-readable medium of claim 1, the method further comprising:
identifying different anomaly thresholds for different operational risk categories; and
storing the different anomaly thresholds within the plurality of anomaly thresholds.

6. The non-transitory computer-readable medium of claim 1, wherein the predicted operational stressor is a predicted bearing temperature and the reported operational stressor value is a reported bearing temperature.

7. The non-transitory computer-readable medium of claim 1, wherein the predicted operational stressor is a predicted bearing vibration and the reported operational stressor value is a reported bearing vibration.

8. The non-transitory computer-readable medium of claim 1, wherein the manufacturing variable is selected from a housing drill diameter, a spacer width, or an axial clearance reduction after assembly.

9. The non-transitory computer-readable medium of claim 1, wherein the features are lagged bearing temperature and lagged and current active power

10. The non-transitory computer-readable medium of claim 1, wherein the at least one variable power generation asset is a wind turbine.

11. The non-transitory computer-readable medium of claim 1, wherein the manufacturing variables for different components of the manufacturing data are related to gearbox components.

12. The non-transitory computer-readable medium of claim 1, wherein the model is one of a plurality of models, each model of the plurality of models being for a different variable power generation asset.

13. The non-transitory computer-readable medium of claim 1, wherein the model includes an XGBoost based learning model.

14. A system, comprising:
at least one processor; and
memory, the memory containing executable instructions, the executable instructions being executable by the at least one processor to:
receive monitoring data from at least one variable power generation asset;
predict, using a trained machine model, a predicted operational stressor value based on features of the monitoring data, the operational stressor value being a stressor metric of an operational stressor of a condition of at least a part of the at least one variable power generation asset;
compare a difference of the predicted operational stressor value to a reported operational stressor value to create a residual value, the reported operational stressor value having been being based on a measurement of the reported operational stressor value of the at least one variable power generation asset;
retrieve a particular anomaly threshold from a plurality of anomaly thresholds, the particular anomaly threshold being selected based on at least one manufacturing variable of a component of the at least one variable power generation asset and a risk category that is based on an operational survivability analysis over time for that at least one manufacturing variable in the presence of the operational stressor, the at least one manufacturing variable being from manufacturing data; and
provide a notification of potential failure when the residual value is outside the particular anomaly threshold.

15. The system of claim 14, wherein the executable instructions are further executable by the at least one processor to:
receive the manufacturing data that includes manufacturing variables for different components of a plurality of variable power generation assets including the at least one manufacturing variable, each manufacturing variable of the manufacturing data including a plurality of dimensional metrics;
for each manufacturing variable:
sort the plurality of dimensional metrics based on size;
perform a manufacturing survivability analysis on different percentile ranges of the sorted dimensional metrics to determine manufacturing risk categories based at least in part on risk of failure over time; and
perform the operational survivability analysis on at least a subset of risk categories to determine operational risk categories based on risk of failure over time in the presence of at least one operational risk variable.

16. The system of claim 15, wherein the executable instructions being executable by the at least one processor to perform the manufacturing survivability analysis on the different percentile ranges of the sorted dimensional metrics to determine the manufacturing risk categories based at least in part on the risk of failure over time comprises the executable instructions being executable by the at least one processor to determine at least one first p-value to determine significance of the different percentile ranges of the sorted dimensional metrics, at least one manufacturing risk category being determined based, at least in part, on the first p-value being sufficiently low.

17. The system of claim 15, wherein the executable instructions being executable by the at least one processor to perform the operational survivability analysis on at least the subset of risk categories to determine the operational risk categories based on the risk of failure over time in the presence of at least one operational risk variable comprises the executable instructions being executable by the at least one processor to determine at least one second p-value to determine significance of the different operational risk categories, at least one operational risk category being determined based, at least in part, on the second p-value being sufficiently low.

18. The system of claim 14, wherein the executable instructions are further executable by the at least one processor to:
identify different anomaly thresholds for different operational risk categories; and
store the different anomaly thresholds within the plurality of anomaly thresholds.

19. The system of claim 14, wherein the predicted operational stressor is a predicted bearing temperature and the reported operational stressor value is a reported bearing temperature.

20. A method, comprising:
receiving monitoring data from at least one variable power generation asset;
predicting, using a trained machine model, a predicted operational stressor value based on features of the monitoring data, the operational stressor value being a stressor metric of an operational stressor of a condition of at least a part of the at least one variable power generation asset;
comparing a difference of the predicted operational stressor value to a reported operational stressor value to create a residual value, the reported operational stressor value having been being based on a measurement of the reported operational stressor value of the at least one variable power generation asset;
retrieving a particular anomaly threshold from a plurality of anomaly thresholds, the particular anomaly threshold being selected based on at least one manufacturing variable of a component of the at least one variable power generation asset and a risk category that is based on an operational survivability analysis over time for that at least one manufacturing variable in the presence of the operational stressor, the at least one manufacturing variable being from manufacturing data; and
providing a notification of potential failure when the residual value is outside the particular anomaly threshold.
